(19) United States
(12) Patent Application Publication
(10) Pub. No.: US 2009/0167691 A1
(43) Pub. Date: Jul. 2, 2009

(54) Foldable Electronic Device

(75) Inventors: Shun-Lung Wang, Taipei (TW); Wen-Chieh Tseng, Taipei (TW); Chia-Lin Tai, Taipei (TW); Chia-Ying Lee, Taipei (TW); Ching-Ke Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTek Computer Inc., Taipei (TW)

(21) Appl. No.: 12/337,953

(22) Filed: Dec. 18, 2008

(30) Foreign Application Priority Data
Dec. 27, 2007 (TW) 96150598

(51) Int. Cl. G06F 3/02

(52) U.S. Cl. 345/168

(57) ABSTRACT

A foldable electronic device includes a main portion, a display portion, a gear set, a saw teeth member and a connection member. The main portion has a top surface. A keyboard is pivotally connected with the top surface of the main portion. The display portion is pivotally connected with the main portion by a rotation shaft such that the display portion is operable to be folded against or unfolded away the top surface. The rotation shaft drives the gear set. The saw teeth member engages with the gear set. The connection member has an end pivotally connected with a bottom surface of the keyboard and an opposite end pivotally connected with the saw teeth member. When the display portion swivels relative to the main portion, the rotation shaft drives the gear set, the saw teeth member and the connection member to move simultaneously so as to swivel the keyboard relative to the top surface.

### RELATED APPLICATIONS

This application claims priority to Taiwan Application Serial Number 96150598, filed Dec. 27, 2007, which are herein incorporated by reference.

### BACKGROUND

1. Field of Invention

The present invention relates to a portable electronic device. More particularly, the present invention relates to a foldable electronic device.

2. Description of Related Art

A conventional notebook computer has several prerequisite steps: unlocking a display portion from a main portion; lifting the display portion to an upright position; turning on the power, etc. before we can use the notebook computer to perform any desired functionality. These steps may not be a burden but somewhat an inconvenience for notebook computer users. For the forgoing reasons, there is a need for improving the notebook computer to enable users to perform these prerequisite steps conveniently and speedily.

### SUMMARY

It is therefore an objective of the present invention to provide a foldable electronic device.

In accordance with the foregoing and other objectives of the present invention, a foldable electronic device includes a main portion, a display portion, a gear set, a saw teeth member and a connection member. The main portion has a top surface. A keyboard is pivotally connected with the top surface of the main portion. The display portion is pivotally connected with the main portion by a rotation shaft such that the display portion is operable to be folded against or unfolded away the top surface. The rotation shaft drives the gear set. The saw teeth member engages with the gear set. The connection member has an end pivotally connected with a bottom surface of the keyboard and an opposite end pivotally connected with the saw teeth member. When the display portion swivels relative to the main portion, the rotation shaft drives the gear set, the saw teeth member and the connection member to move simultaneously so as to swivel the keyboard relative to the top surface.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a foldable electronic device with its display portion folded against its main portion according to one preferred embodiment of this invention;

FIG. 2 illustrates the foldable electronic device as illustrated in FIG. 1 with its display portion unfolded away its main portion;

FIG. 3 illustrates the foldable electronic device as illustrated in FIG. 1 with its display portion being unfolding away from its main portion;

FIG. 4 illustrates the foldable electronic device as illustrated in FIG. 1 with its display portion being folding closer to its main portion;

FIG. 5 illustrates a cross-sectional view of the foldable electronic device as illustrated in FIG. 3; and

FIG. 6 illustrates a cross-sectional view of the foldable electronic device as illustrated in FIG. 4.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

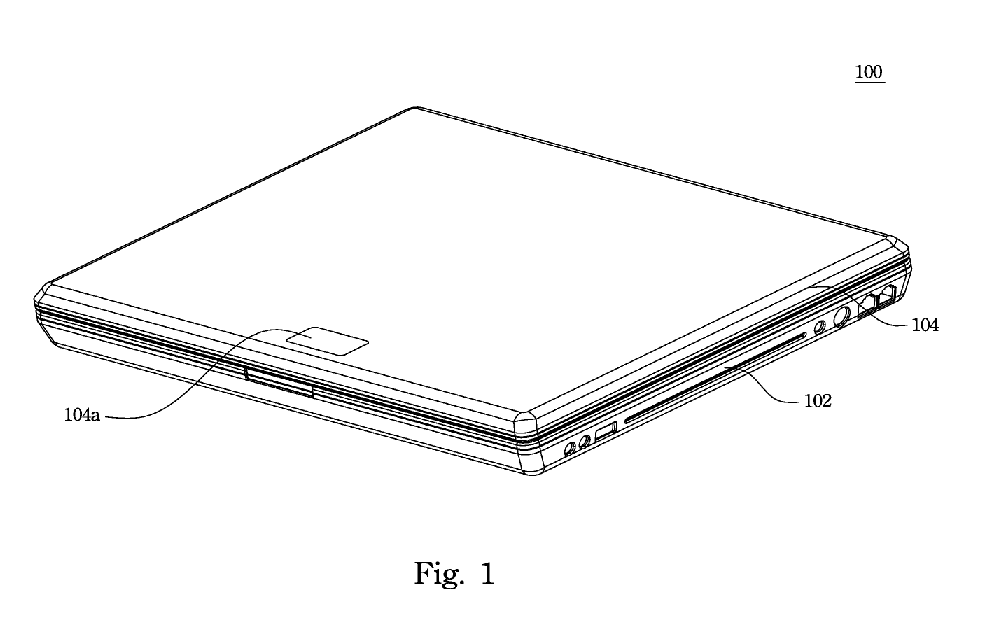

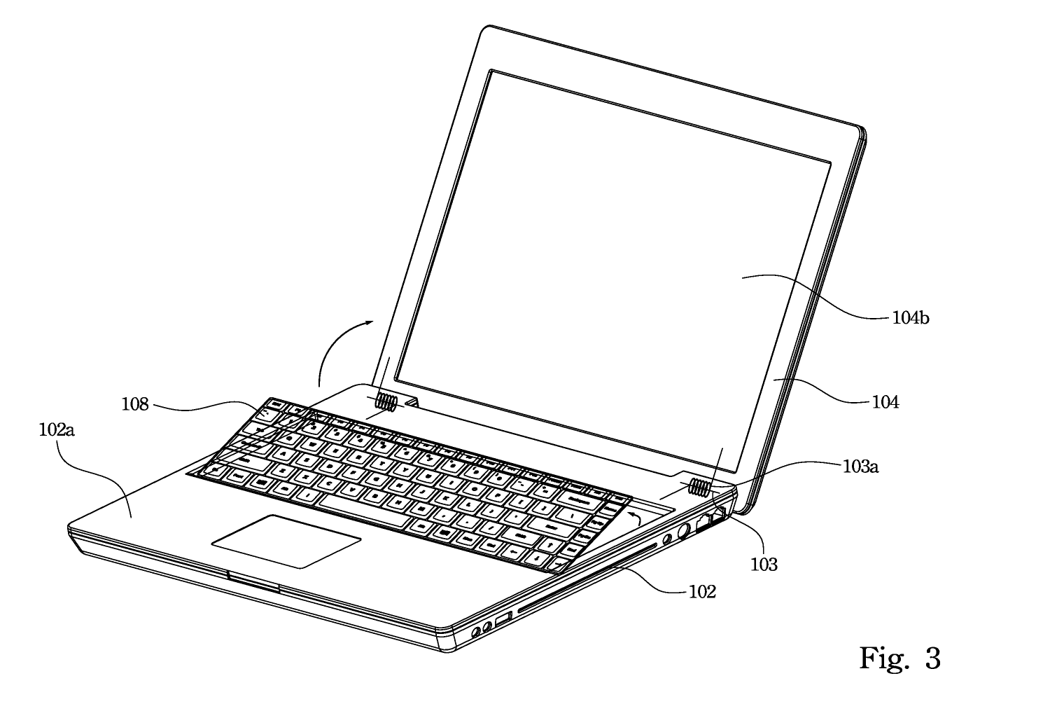

FIG. 1 illustrates a foldable electronic device (such as notebook computer) with its display portion folded against its main portion according to one preferred embodiment of this invention. The foldable electronic device 100 includes a main portion 102 and a display portion 104. The display portion 104 is pivotally connected with the main portion 102. The display portion 104 has a display screen 104b (see FIG. 3). When the foldable electronic device 100 is idle, the display portion 104 is folded against and secured to the main portion 102 such that the display screen 104b is protected therebetween. In this embodiment, the display portion has a fingerprint recognition device 104a for controlling whether or not the display portion 104 is secured to the main portion 102. When an owner of the foldable electronic device 100 places his or her finger upon the fingerprint recognition device 104a, the display portion 104 can be unlocked from the main portion 102. The fingerprint recognition device 104a and the display screen 104b are respectively located on two opposite surfaces of the display portion 104.

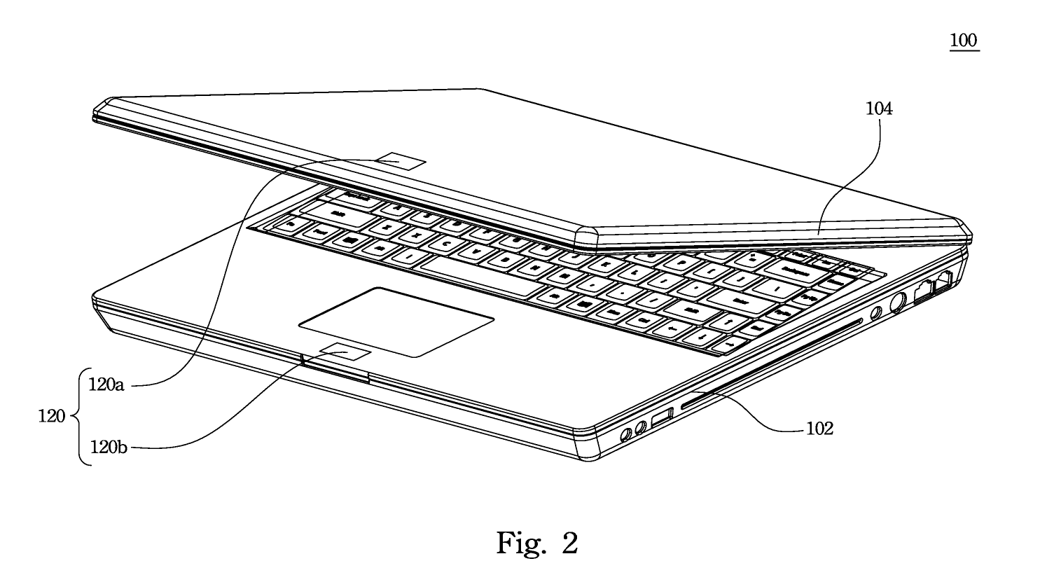

FIG. 2 illustrates the foldable electronic device as illustrated in FIG. 1 with its display portion unfolded away its main portion. In this embodiment, an electromagnetic lock mechanism 120 is used to secure the display portion 104 to the main portion 102. The electromagnetic lock mechanism 120 includes an electromagnet 120b (located on the main portion 120) and a metallic member 120a (located on the display portion 104). When the electromagnet 120b is electrified, the electromagnet 120b attracts the metallic member 120a such that the display portion 104 is secured to the main portion 102 (see FIG. 1). When the electromagnet 120b is not electrified, the electromagnet 120b does not attract the metallic member 120a such that the display portion 104 can be swiveled at will relative to the main portion 102 (see FIG. 2). The fingerprint recognition device 104a is operable to control whether or not the electromagnet 120b is electrified. When an owner of the foldable electronic device 100 places his or her finger upon the fingerprint recognition device 104a, the electromagnet 120b is not electrified, and the display portion 104 can be unlocked from the main portion 102 and swiveled at will.

FIG. 3 illustrates the foldable electronic device as illustrated in FIG. 1 with its display portion being unfolding away from its main portion. When the display portion 104 is unfolding away from the main portion 102, a keyboard 108, which is pivotally connected with a top surface 102a by one edge, is simultaneously swiveled to an inclined status beneficial for typing. In this embodiment, the display portion 104 is swiveled by means of two torsion springs 103a. Each torsion spring 103a is arranged around the rotation shaft 103, which pivotally interconnects the display portion 104 and the main portion 102. Each torsion spring 103a has an end secured to the main portion 102 and an opposite end secured to the display portion 104. When the display portion 104 is unlocked from the main portion 102, the torsion springs 103a provides rotation torques to swivel or rotate the display portion 104 away from the main portion 102. Users are thus free from exerting any force to lift the display portion 104 away from the main portion 102. How swiveling the display portion 104 simultaneously swivels the keyboard 108 to an inclined status is described below.

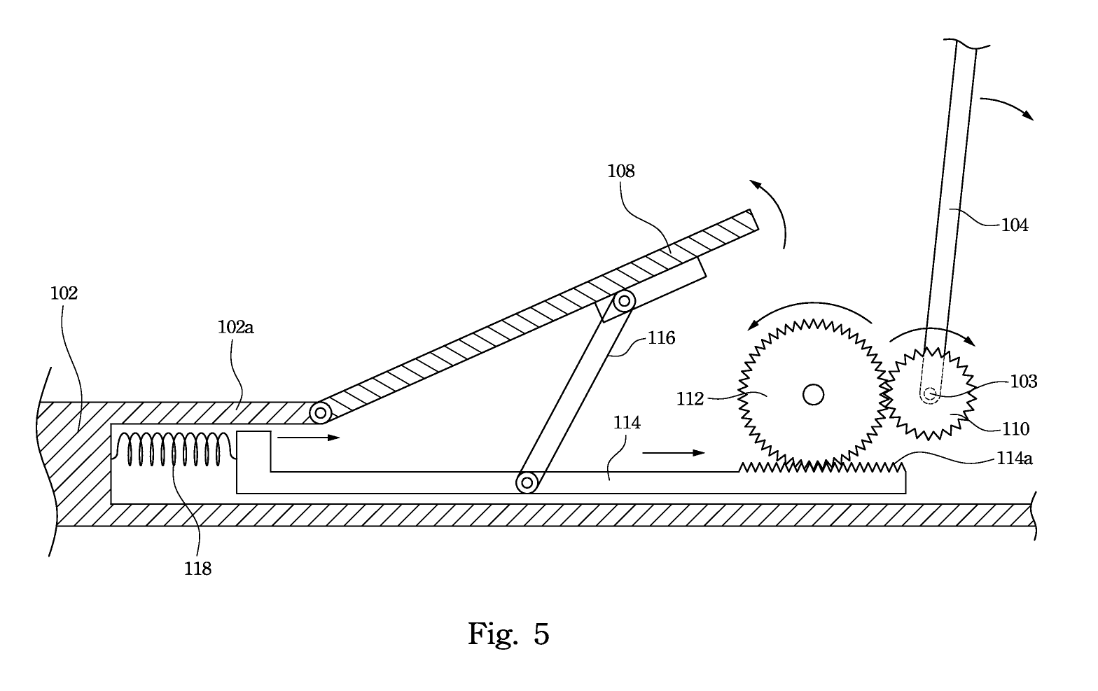

Referring both FIG. 3 and FIG. 5, when the display portion 104 is being unfolded away from the main portion 102, a transmission mechanism is utilized to swivel the keyboard 108 simultaneously. The transmission mechanism includes a gear 110, a gear 112, a saw teeth member 114 and a connection member 116. The gear 110, which has a circular saw teeth around thereof, is fixed to the rotation shaft 103 so as to rotate simultaneously with the rotation shaft 103 when the display portion 104 is being swiveled. The gear 112, which has a circular saw teeth around thereof, engages between the gear 110 and the saw teeth member 114, i.e. the gear 112 meshes with the gear 110 at one side and meshes with the saw teeth member 114 at the other side. The connection member 116 has an end pivotally connected with a bottom surface of the keyboard 108 and an opposite end pivotally connected with the saw teeth member 114. Referring to FIG. 5, when the display portion 104 is being unfolded away from the main portion 102 along a corresponding arrow, the gear 110, the gear 112, the saw teeth member 114 and the connection member 116 are all simultaneously moved along their corresponding arrows, and the keyboard 108 is simultaneously swiveled along its corresponding arrow to an inclined status beneficial for typing. In addition, a compression spring 118 has an end secured to the main portion 102 and an opposite end secured to the saw teeth member 114. Thus, the compression spring 118 provides a push force to the saw teeth member 114 so as to smoothen the transmission mechanism's operation.

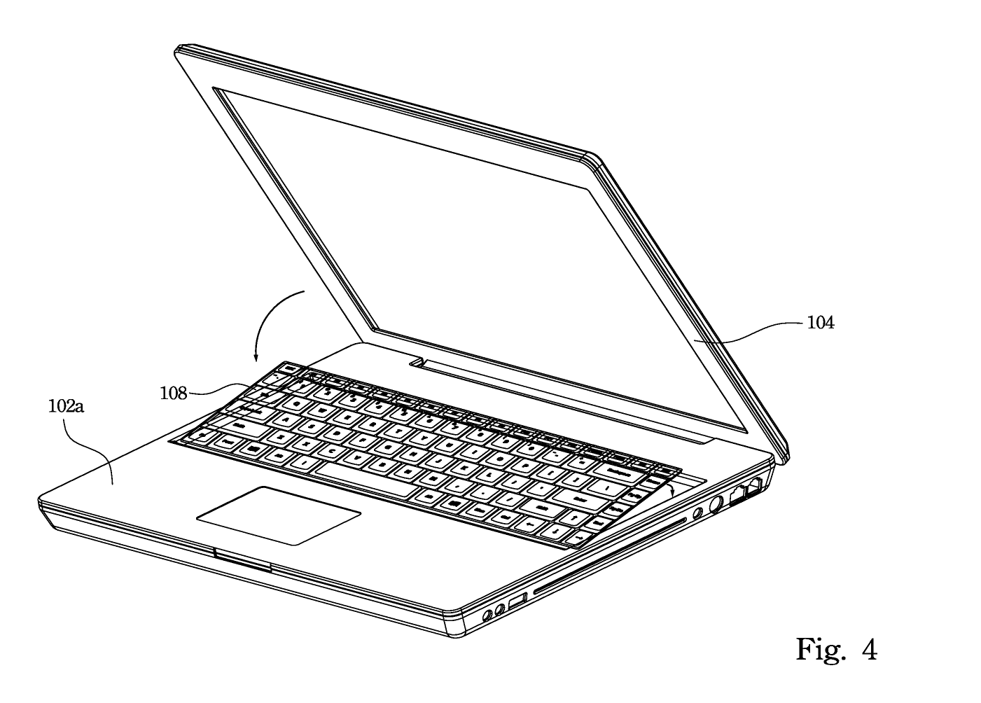

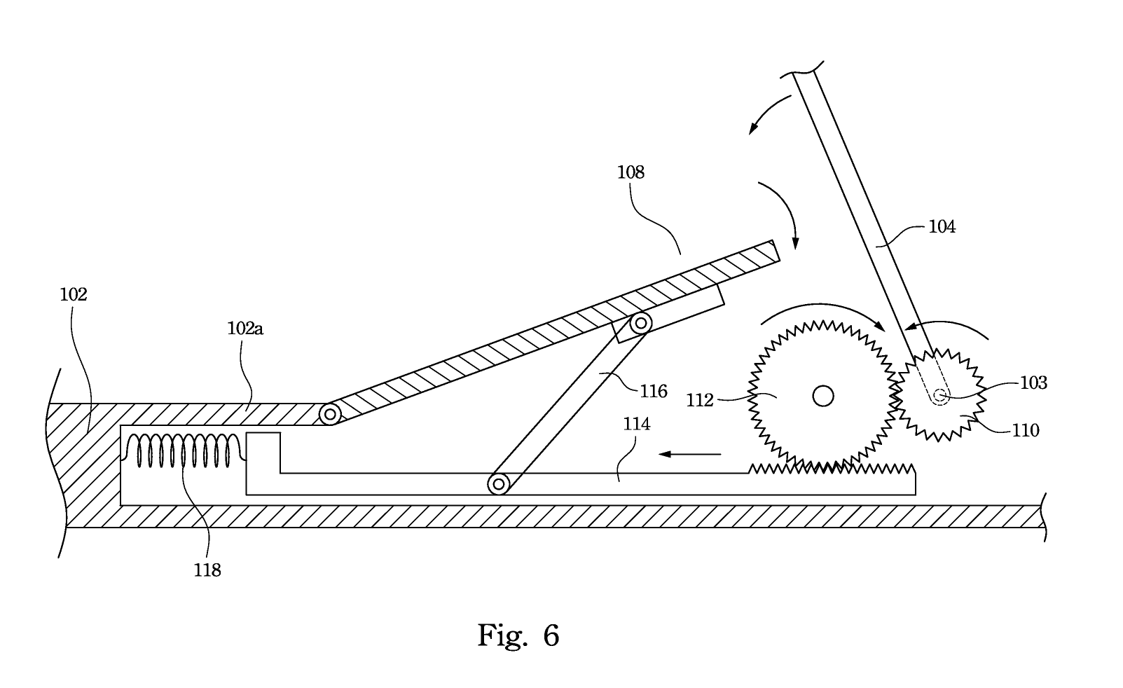

Referring to both FIG. 4 and FIG. 6, when the display portion 104 is being folded closer to the main portion 102, the keyboard 108 is simultaneously swiveled closer to the top surface 102a. Referring to FIG. 6, when the display portion 104 is being folded closer to the main portion 102 along a corresponding arrow, the gear 110, the gear 112, the saw teeth member 114 and the connection member 116 are all simultaneously moved along their corresponding arrows, and the keyboard 108 is simultaneously swiveled along its corresponding arrow closer to the top surface 102a. Thus, the keyboard 108 would not be pressed by the display portion 104 when the display portion 104 is being folded closer to the main portion 102. The saw teeth member 114 is moved along its corresponding arrow to compress the compression spring 118.

According to discussed embodiments, the present invention provides a foldable electronic device, which is equipped with a transmission mechanism. When the display portion is unfolded away the main portion to a working mode, a keyboard is simultaneously swiveled to an inclined status beneficial for typing. Moreover, a fingerprint recognition device and an electromagnetic lock mechanism are both installed on the foldable electronic device to enable users to lift the display portion away from the main portion conveniently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A foldable electronic device, comprising:
a main portion having a top surface;
a keyboard pivotally connected with the top surface of the main portion;
a display portion pivotally connected with the main portion by a rotation shaft such that the display portion is operable to be folded against or unfolded away the top surface;
a gear set being driven by the rotation shaft;
a saw teeth member engaging with the gear set; and
a connection member having an end pivotally connected with a bottom surface of the keyboard and an opposite end pivotally connected with the saw teeth member,
when the display portion swivels relative to the main portion, the rotation shaft drives the gear set, the saw teeth member and the connection member to move simultaneously so as to swivel the keyboard relative to the top surface.

2. The foldable electronic device of claim 1, further comprising a torsion spring disposed around the rotation shaft, wherein the torsion spring has an end secured to the main portion and an opposite end secured to the display portion.

3. The foldable electronic device of claim 1, further comprising a compression spring, which has an end secured to the main portion and an opposite end secured to the saw teeth member.

4. The foldable electronic device of claim 1, wherein the display portion comprises a fingerprint recognition device.

5. The foldable electronic device of claim 4, wherein the display portion comprises a display screen.

6. The foldable electronic device of claim 5, wherein the display screen and the fingerprint recognition device are disposed on two opposite surfaces of the display portion.

7. The foldable electronic device of claim 1, further comprising an electromagnetic lock mechanism, when the display portion is folded against the top surface of the main portion, the electromagnetic lock mechanism fastens the display portion to the main portion.

8. The foldable electronic device of claim 7, wherein the electromagnetic lock mechanism comprises an electromagnet disposed on the main portion and a metallic member disposed on the display portion.

9. The foldable electronic device of claim 1, wherein the gear set comprises a first gear and a second gear, the first gear being secured to the rotation shaft, the second gear engaging between the first gear and the saw teeth member.
